(19) United States
(12) Patent Application Publication
(10) Pub. No.: US 2002/0117029 A1
(43) Pub. Date: Aug. 29, 2002

(54) Pliers

(76) Inventor: Chang-Chuan Lin, Gia Yi Hsien (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/795,566

(22) Filed: Feb. 28, 2001

(51) Int. Cl. B25B 7/02

(52) U.S. Cl. 81/423

(57) ABSTRACT

A pair of pliers has a pair of jaw support frames engaging with each other, and two jaw blocks. Each jaw block has a mount having at least a round hole, a ball, a spring, and a threaded disk. The ball, the spring and the threaded disk are inserted in the round hole of the mount. Each jaw support frame has two parallel plates and a spacing defined between the parallel plates. Each plate has at least a through hole. Each mount is inserted in the corresponding spacing of the jaw support frame.

### BACKGROUND OF THE INVENTION

The present invention relates to a pair of pliers. More particularly, the present invention relates to a pair of pliers which has two jaw blocks to be detached easily.

Referring to FIG. 1, a pair of conventional pliers 5 has two jaws 51 and two cutters 52 disposed on two jaws 51. Since the jaws 51 and the cutters 52 are fastened together, it is difficult to detach the cutters 52 from the jaws 51.

### SUMMARY OF THE INVENTION

An object of the present invention is to provide a pair of pliers which has two jaw blocks to be detached easily.

Accordingly, a pair of pliers comprises a pair of jaw support frames engaging with each other and two jaw blocks. Each of the jaw support frames has two parallel plates and a spacing defined between the parallel plates. Each mount is inserted in the corresponding spacing of the jaw support frame.

In accordance with a first preferred embodiment of the present invention, a pair of pliers comprises a pair of jaw support frames engaging with each other, and two jaw blocks. Each of the jaw blocks has a mount having at least a round hole, a ball, a spring, and a threaded disk. The ball, the spring and the threaded disk are inserted in the round hole of the mount. Each of the jaw support frames has two parallel plates and a spacing defined between the parallel plates. Each of the plates has at least a through hole. Each mount is inserted in the corresponding spacing of the jaw support frame.

In accordance with a second preferred embodiment of the present invention, a pair of pliers comprises at least a jaw support frame and at least a jaw block. The jaw block has a mount having two blind holes. The jaw support frame has two parallel plates and a spacing defined between the parallel plates. Each of the plates has two through holes and two threaded apertures. The mount is inserted in the corresponding spacing of the jaw support frame. A panel has two threaded holes, an oblong recess, and an oblong groove. A spring is inserted in the oblong recess of the panel. An oblong bar is inserted in the oblong recess and the oblong groove of the panel. The oblong bar has two recess holes. Two balls are inserted in the through holes of one of the plates. The panel and one of the plates are fastened together.

In accordance with a third preferred embodiment of the present invention, a pair of pliers comprises at least a jaw support frame and at least a jaw block. The jaw block has a mount having a first magnet. The jaw support frame has two parallel plates and a spacing defined between the parallel plates. The mount is inserted in the corresponding spacing of the jaw support frame. Each of the plates has a second magnet attracting the first magnet.

In accordance with a fourth preferred embodiment of the present invention, a pair of pliers comprises at least a jaw support frame and at least a jaw block. The jaw block has a mount having a first recess and a first groove. The jaw support frame has two parallel plates, a shaft disposed between the parallel plates, a hooking ring connected to the the parallel plates, and a spacing defined between the parallel plates. The mount is inserted in the corresponding spacing of the jaw support frame. Each of the plates has a second recess. The shaft is inserted in the first groove of the mount. The hooking ring is inserted in the second recess of the plate.

In accordance with a fifth preferred embodiment of the present invention, a pair of pliers comprises at least a jaw support frame and at least a jaw block. The jaw block has a mount having two recesses and a slot. The jaw support frame has two parallel plates and a spacing defined between the parallel plates. The mount is inserted in the corresponding spacing of the jaw support frame. Each of the plates has a groove. A flexible ring is inserted in the slot of the mount. The flexible ring has two protruded blocks and two curved portions.

### BRIEF DESCRIPTION OF THE DRAWINGS

FIG. 1 is an elevational view of a pair of pliers of the prior art;

FIG. 2 is a partially perspective exploded view of a pair of pliers of a first preferred embodiment in accordance with the present invention;

FIG. 3 is a partially perspective exploded view of a pair of pliers of a second preferred embodiment in accordance with the present invention;

FIG. 4 is a partially sectional assembly view of a pair of pliers of a second preferred embodiment in accordance with the present invention;

FIG. 4A is another partially sectional assembly view of a pair of pliers of a second preferred embodiment in accordance with the present invention;

FIG. 5 is a partially perspective exploded view of a pair of pliers of a third preferred embodiment in accordance with the present invention;

FIG. 6 is a partially perspective exploded view of a pair of pliers of a fourth preferred embodiment in accordance with the present invention;

FIG. 7 is a partially sectional assembly view of a pair of pliers of a fourth preferred embodiment in accordance with the present invention;

FIG. 8 is a partially perspective exploded view of a pair of pliers of a fifth preferred embodiment in accordance with the present invention; and

FIG. 9 is a schematic view illustrating an operation of a pair of pliers of a fifth preferred embodiment in accordance with the present invention.

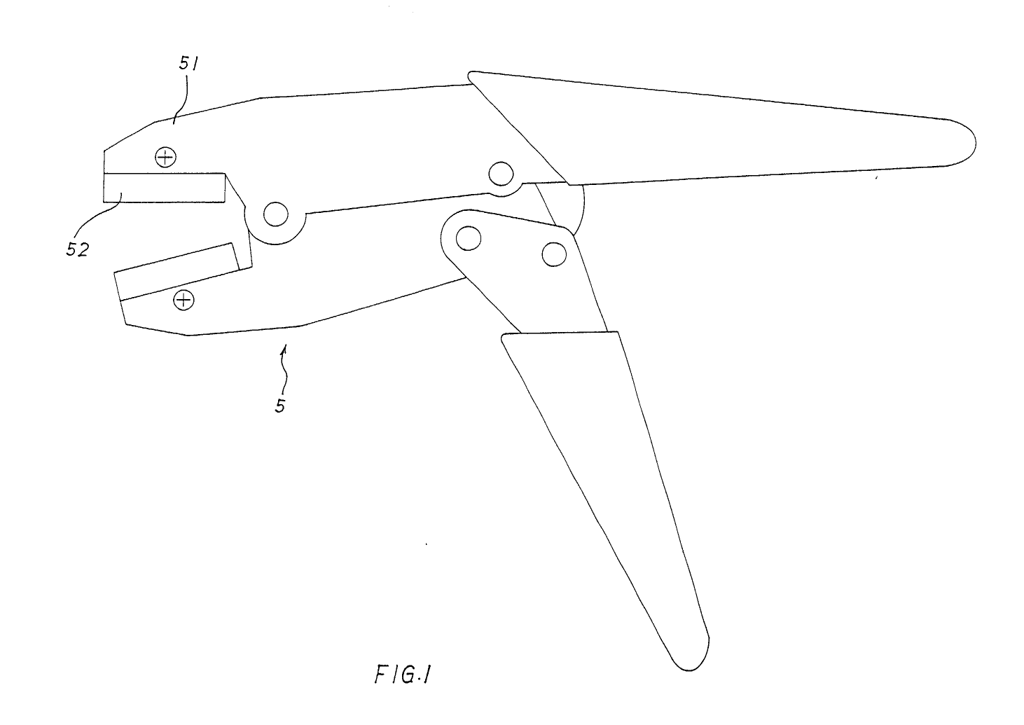

### DETAILED DESCRIPTION OF THE INVENTION

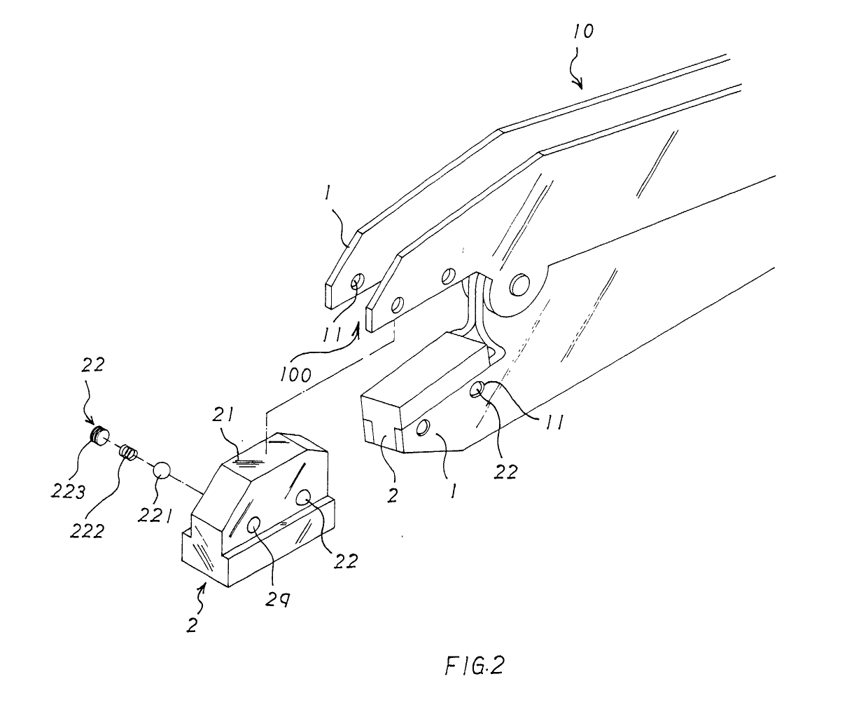

Referring to FIG. 2, a first pair of pliers comprises a pair of jaw support frames 10 engaging with each other, and two jaw blocks 2.

Each of the jaw blocks 2 has a mount 21 having at least a round hole 20, a ball 221, a spring 222, and a threaded disk 223.

The ball 221, the spring 222 and the threaded disk 223 are inserted in the round hole 20 of the mount 21.

Each of the jaw support frames 10 has two parallel plates 1 and a spacing 100 defined between the parallel plates 1.

Each of the plates 1 has at least a through hole 11.

Each mount 21 is inserted in the corresponding spacing 100 of the jaw support frame 10.

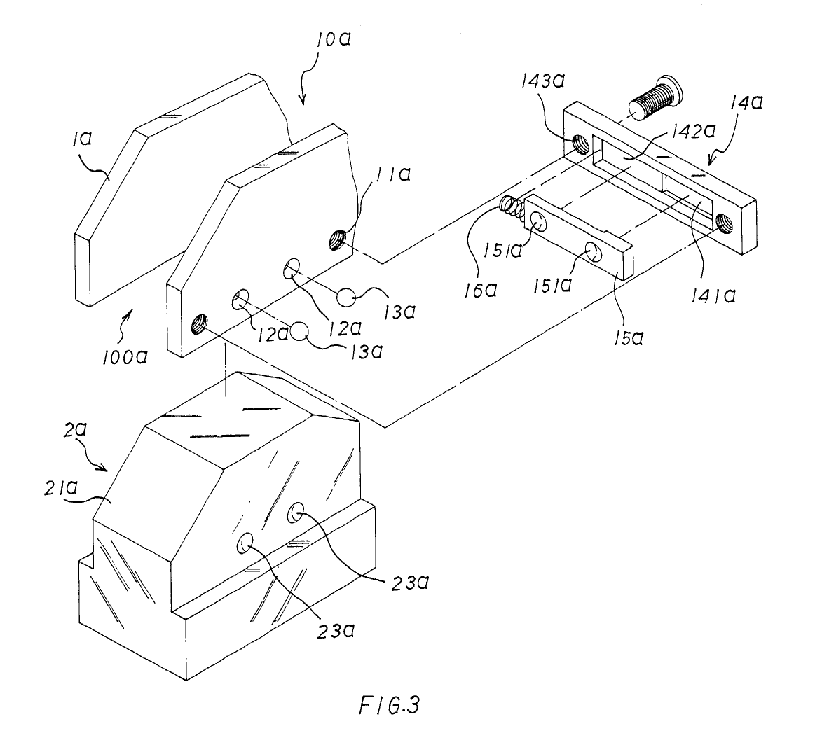

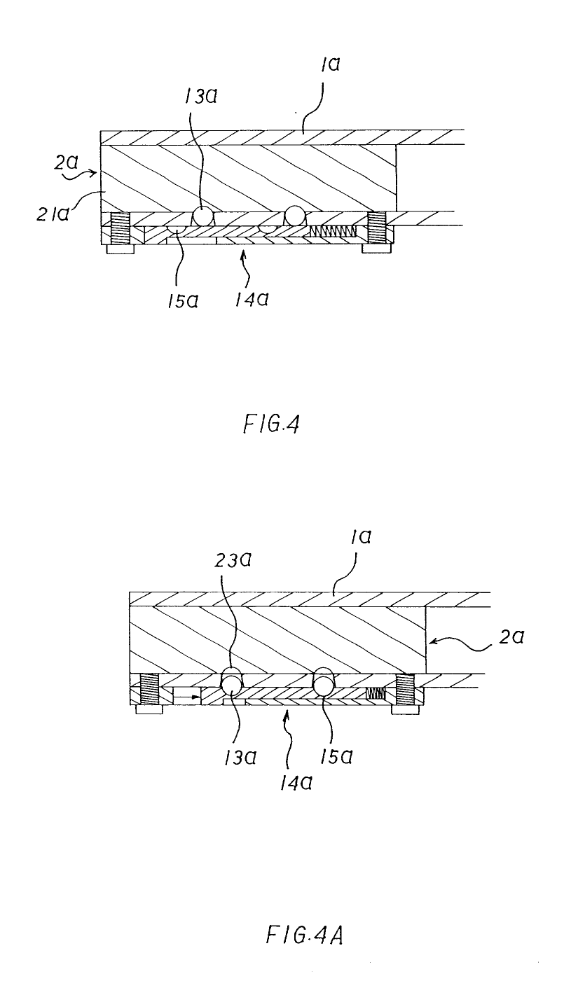

Referring to FIGS. 3, 4 and 4A, a second pair of pliers comprises at least a jaw support frame 10a and at least a jaw block 2a.

The jaw block 2a has a mount 21a having two blind holes 23a.

The jaw support frame 10a has two parallel plates 1a and a spacing 100a defined between the parallel plates 1a.

Each of the plates 1a has two through holes 12a and two threaded apertures 11a.

The mount 21a is inserted in the corresponding spacing 100a of the jaw support frame 10a.

A panel 14a has two threaded holes 143a, an oblong recess 142a, and an oblong groove 141a.

A spring 16a is inserted in the oblong recess 142a of the panel 14a.

An oblong bar 15a is inserted in the oblong recess 142a and the oblong groove 141a of the panel 14a.

The oblong bar 15a has two recess holes 151a.

Two balls 13a are inserted in the through holes 12a of one of the-plates 1a.

The panel 14a and one of the plates 1a are fastened together.

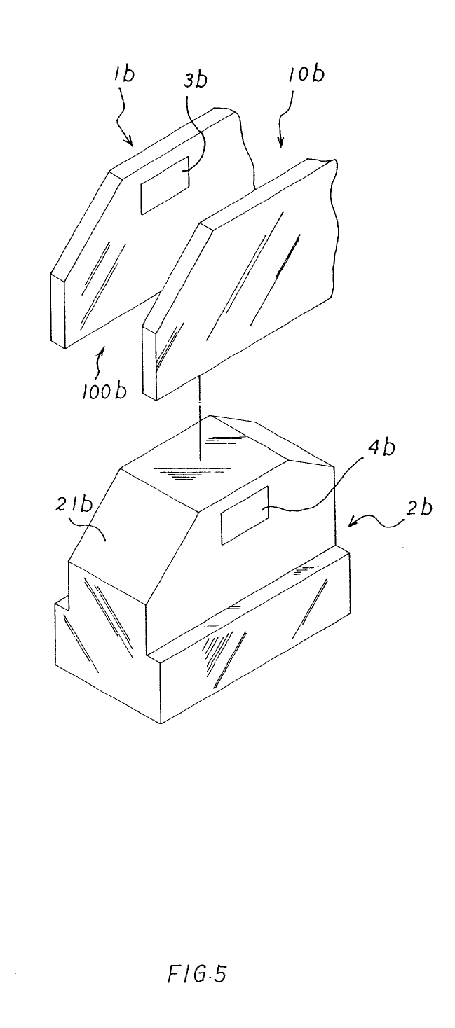

Referring to FIG. 5, a third pair of pliers comprises at least a jaw support frame 10b and at least a jaw block 2b.

The jaw block 2b has a mount 21b having a first magnet 4b.

The jaw support frame 10b has two parallel plates 1b and a spacing 100b defined between the parallel plates 1b.

The mount 21b is inserted in the corresponding spacing 100b of the jaw support frame 10b.

Each of the plates 1b has a second magnet 3b attracting the first magnet 4b.

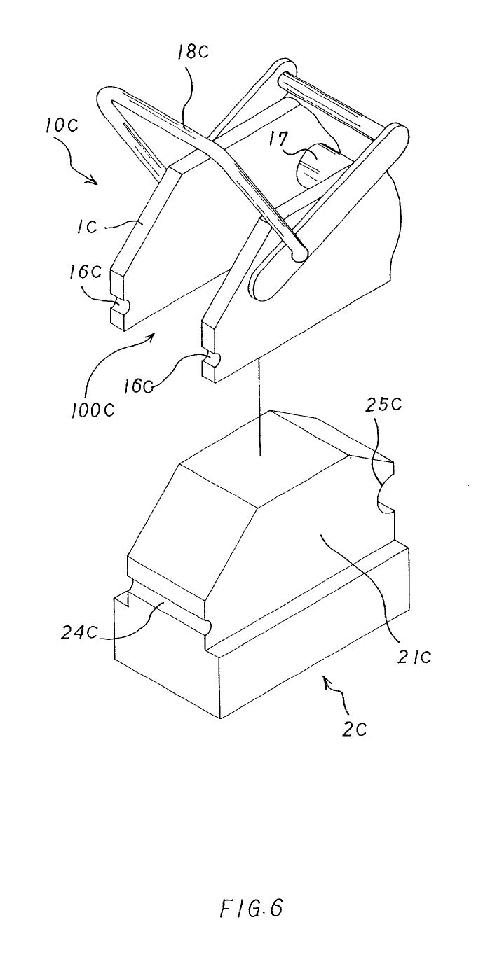

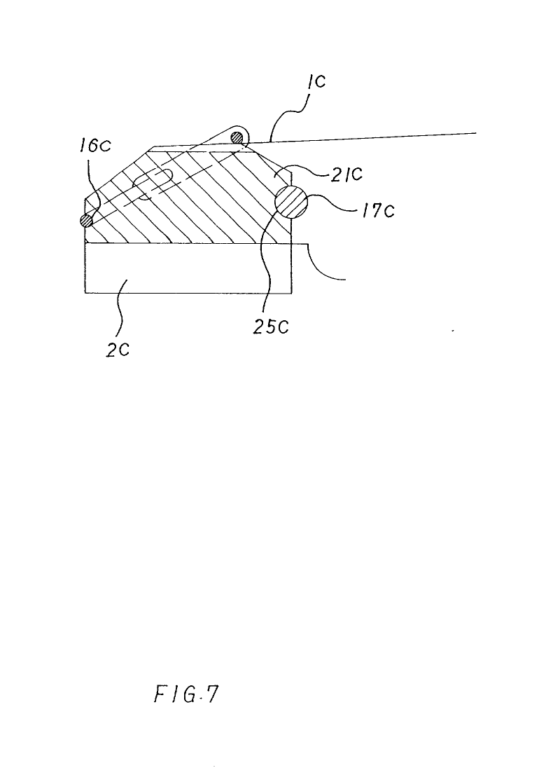

Referring to FIGS. 6 and 7, a fourth pair of pliers comprises at least a jaw support frame 10c and at least a jaw block 2c.

The jaw block 2c has a mount 21c having a first recess 24c and a first groove 25c.

The jaw support frame 10c has two parallel plates 1c, a shaft 17c disposed between the parallel plates 1c, a hooking ring 18c connected to the the parallel plates 1c, and a spacing 100c defined between the parallel plates 1c.

The mount 21c is inserted in the corresponding spacing 100c of the jaw support frame 1c.

Each of the plates 1c has a second recess 16c.

The shaft 17c is inserted in the first groove 25c of the mount 21c.

The hooking ring 18c is inserted in the second recess 16c of the plate 1c.

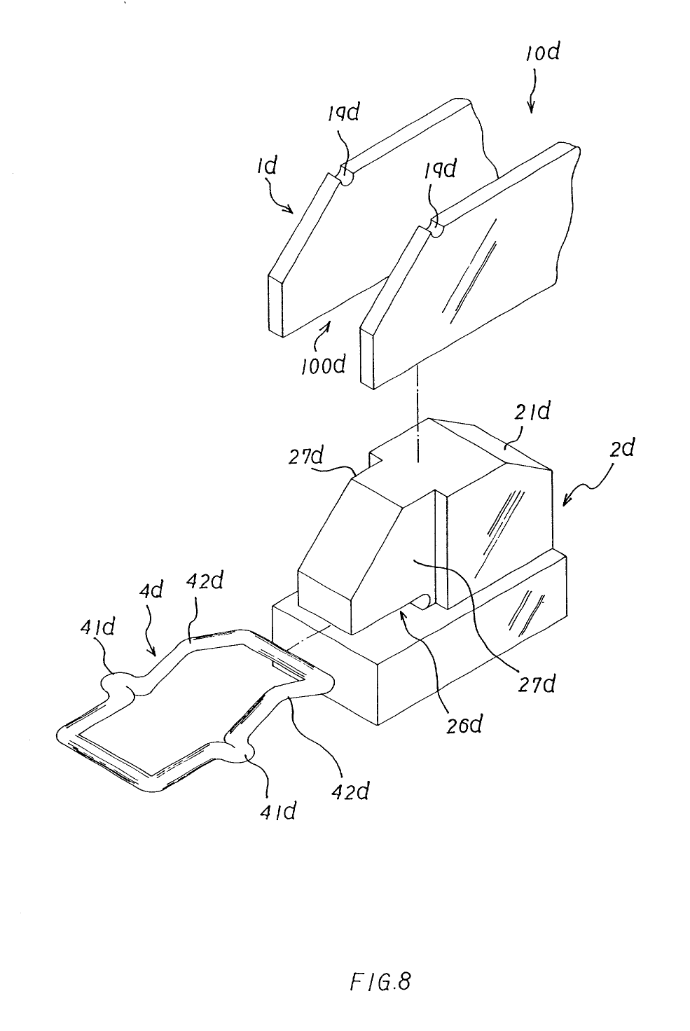

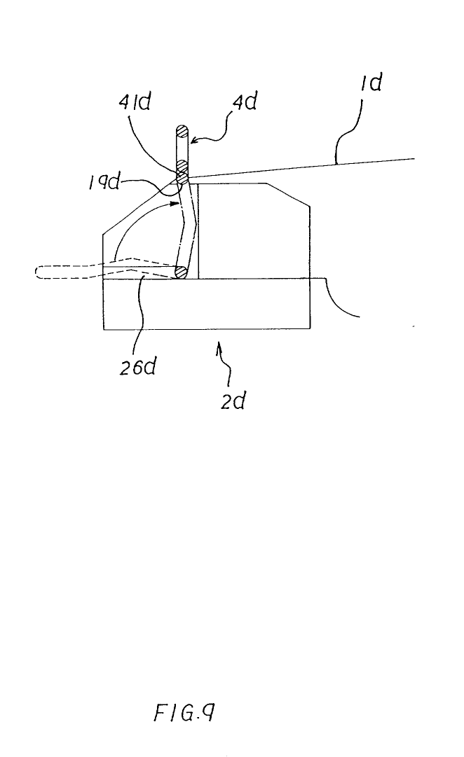

Referring to FIGS. 8 and 9, a fifth pair of pliers comprises at least a jaw support frame 10d and at least a jaw block 2d.

The jaw block 2d has a mount 21d having two recesses 24d and a slot 26d.

The jaw support frame 10d has two parallel plates 1d and a spacing 100d defined between the parallel plates 1d.

The mount 21d is inserted in the corresponding spacing 100d of the jaw support frame 10d.

Each of the plates 1d has a groove 19d.

A flexible ring 4d is inserted in the slot 26d of the mount 21d.

The flexible ring 4d has-two protruded blocks 41d and two curved portions 42d.

The invention is not limited to the above embodiment but various modification thereof may be made. Further, various changes in form and detail may be made without departing from the scope of the invention.

I claim:

1. A pair of pliers comprises:
a pair of jaw support frames engaging with each other and two jaw blocks,
each said jaw support frame having two parallel plates and a spacing defined between the parallel plates, and
each said mount inserted in the corresponding spacing of the jaw support frame.

2. The pair of pliers as claimed in claim 1, wherein each said jaw block has a mount having a first magnet and each said plate has a second magnet attracting the first magnet.

3. The pair of pliers as claimed in claim 1, wherein each said jaw block has a mount having at least a round hole, a ball, a spring and a threaded disk, and the ball, the spring-and the threaded disk are inserted in the round hole of the mount.

4. The pair of pliers as claimed in claim 1, wherein each said plate has two through holes and two threaded apertures, a panel has two threaded holes, an oblong recess, and an oblong groove, a spring is inserted in the oblong recess of the panel. An oblong bar is inserted in the oblong recess and the oblong groove of the panel, the oblong bar has two recess holes, two balls are inserted in the through holes of one of the plates, and the panel and one of the plates are fastened together.
